(19) United States
(12) Patent Application Publication
(10) Pub. No.: US 2009/0291636 A1
(43) Pub. Date: Nov. 26, 2009

(54) System and method for locating a device

(76) Inventors: James Roger Morley-Smith, Buckinghamshire (GB); Richard Linsley-Hood, Binfield (GB)

Correspondence Address: MOTOROLA, INC., 1303 EAST ALGONQUIN ROAD, IL01/3RD, SCHAUMBURG, IL, 60196, US

(21) Appl. No.: 12/123,667

(22) Filed: May 20, 2008

(51) Int. Cl. H04B 7/26; H04M 1/00

(52) U.S. Cl. 455/41.2; 455/556.1

(57) ABSTRACT

Described are a system and a method for locating a device. The system includes a mobile device associated with a network via a wireless transceiver, the mobile device including an audio output component; and a network component receiving a query and generating a command signal to be transmitted to the mobile device in response to the query, the command signal indicating to the mobile device to activate the audio output component. A sound emitted from the audio output component is used to locate the mobile device when a location of the mobile device is unknown.

### FIELD OF THE INVENTION

The present invention relates generally to a system and method for locating a device. Specifically, the device is equipped with an audio component that is activated so that the device is located.

### BACKGROUND

A mobile unit may be used in a variety of environments. For example, the mobile unit may be a product scanner used in a warehouse facility or a retail environment. During the course of use in one of these environments, there arise scenarios where the MU may be misplaced or lost. For example, while taking stock of a group of items, a user may be called to a different location. The user may place the MU down but may forget where the MU is located when trying to recall at a later time. Current methods of locating lost mobile units may include processes that require a large drain on a portable power supply of the mobile unit. Thus, only a small window may exist to discover the location of the mobile unit when lost.

### SUMMARY OF THE INVENTION

The present invention relates to a system and a method for locating a device. The system includes a mobile device associated with a network via a wireless transceiver, the mobile device including an audio output component; and a network component receiving a query and generating a command signal to be transmitted to the mobile device in response to the query, the command signal indicating to the mobile device to activate the audio output component. A sound emitted from the audio output component is used to locate the mobile device when a location of the mobile device is unknown.

### DESCRIPTION OF THE DRAWINGS

FIG. 1 shows a mobile unit according to an exemplary embodiment of the present invention.

FIG. 2 shows an example of a misplaced mobile unit in a network according to an exemplary embodiment of the present invention.

FIG. 3 shows a method for locating a lost mobile unit according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a mobile unit (MU) that is in an unknown location within an operating area of a network (e.g., lost). According to the exemplary embodiments of the present invention, the MU may include an audio output component that may be activated to enable the MU to be found. The MU, the network, the audio output component, and an associated method will be discussed in further detail below.

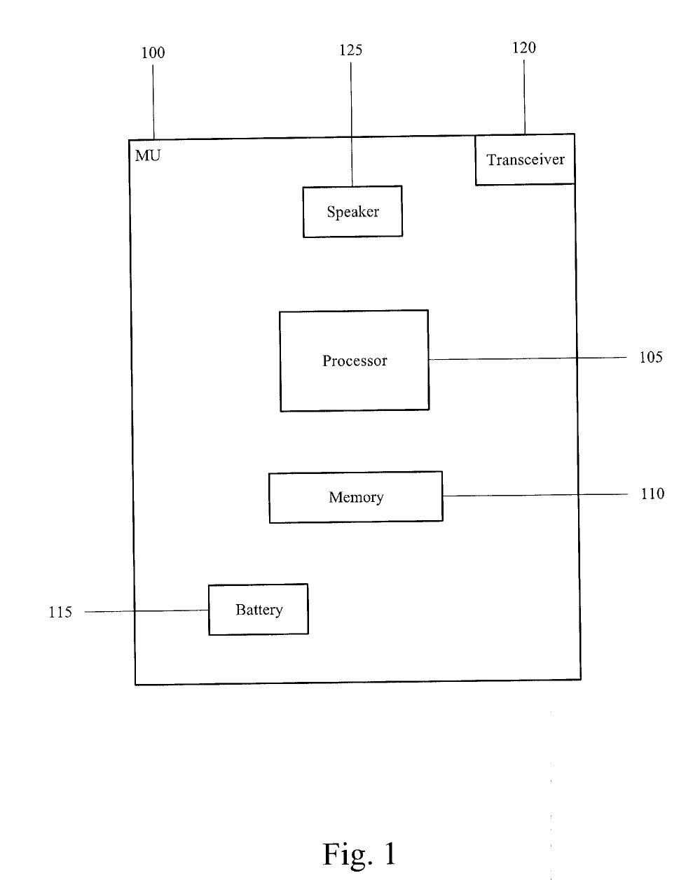

FIG. 1 shows a mobile unit (MU) 100 according to an exemplary embodiment of the present invention. The MU 100 may be any portable electronic device such as a mobile computer, a personal digital assistant (PDA), a laptop, a cell phone, a radio frequency identification reader, a scanner, an image capturing device, a pager, etc. The MU 100 may include a processor 105, a memory 110, a battery 115, a transceiver 120, and a speaker 125.

The processor 105 may be responsible for executing various functionalities of the MU 100. As will be explained in further detail below, according to the exemplary embodiments of the present invention, the processor 105 may be responsible for executing an application so that a location of the MU 100 may be discovered. The application may be a program executed by the processor 105. The memory 110 may be a storage unit for the MU 100. The memory 110 may store the application as well as data and/or settings pertaining to various other functionalities of the MU 100. The MU 100 may include the battery 115 to supply the necessary energy to operate the MU 100. The battery 115 may be a rechargeable battery such as a nickel-cadmium battery, a lithium hydride battery, a lithium ion battery, etc. It should be noted that the term “battery” may represent any portable power supply that is capable of providing energy to the MU 100. For example, the battery 115 may also be a capacitor, a supercapacitor, etc.

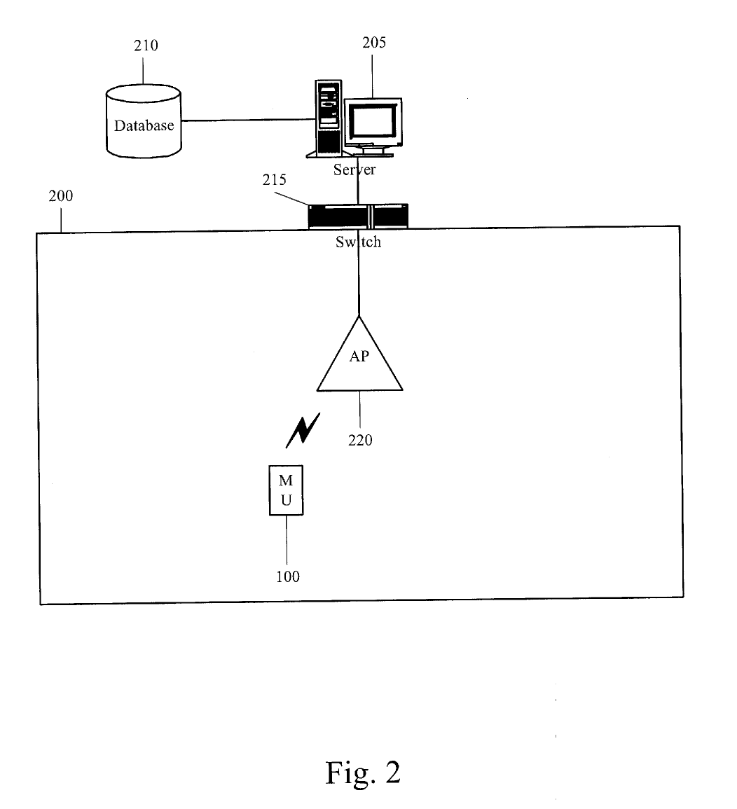

The transceiver 120 may be a component enabling the MU 100 to transmit and receive wireless signals. The transceiver 120 may enable the MU 100 to associate with a wireless network such as a local area network, a wide area network, etc. An exemplary wireless network will be described below with reference to FIG. 2. According to the exemplary embodiments of the present invention, the transceiver 120 may be activated independent of a state of the MU 100. For example, when the MU 100 is in an active state, all the components of the MU 100 may be activated including the transceiver 120. In another example, when the MU 100 is in a suspend state, the components of the MU 100 may be deactivated but the transceiver 120 remains activated. It should be noted that the term “activated” in reference to the exemplary embodiments of the present invention relates to the transceiver 120 being available for use. That is, the transceiver 120 may be in a low power consumption mode but still available to receive wireless signals. Accordingly, the processor 105 may also be activated but activities of the processor 105 may be limited to those needed for the transceiver 120.

The speaker 125 may be any audio output component. In a first exemplary embodiment, the speaker 125 may output a predetermined sound such as a beep. The speaker 125 may receive signals from the processor 105 that indicate a type of audio to be output by the speaker 125. According to the exemplary embodiments of the present invention, the transceiver 120 may receive a wireless signal that is forwarded to the processor 105. The processor 105 may then send an audio signal to be played by the speaker 125.

FIG. 2 shows a network 200 in which the MU 100 of FIG. 1 is lost according to an exemplary embodiment of the present invention. The network 200 may include an operating area in which the MU 100 may be disposed and be associated therewith. The network 200 may include a server 205, a database 210, a switch 215, and an access point (AP) 220. It should be noted that the network 200 is only exemplary. That is, any network architecture may be used.

The server 205 may be configured to be responsible for the operations occurring within the network 200. Specifically, the server 205 may generate a signal that is to be received by the MU 100. The signal may include a command that causes an audio output from the speaker 125 of the MU 100. The database 210 may store data relating to the network 200 such as association lists. That is, the database 210 may be aware of the MUs including the MU 100 that are disposed in the operating area of the network 200. The network 200 may further include the switch 215 to direct data appropriately.

The network 200 may incorporate the AP 220 to extend a coverage area (i.e., the operating area) so that the MU 100 may connect to the network 200 in a greater number of locations. The AP 220 includes an individual coverage area that is part of an overall coverage area of the network 200. That is, the AP 220 may serve as an intermediary for a transmission from the MU 100 to other network components. As illustrated, the MU 100 is wirelessly associated with the network 200 via the AP 220. It should be noted that the network 200 may include further APs to further extend the coverage area of the network 200.

According to the exemplary embodiments of the present invention, the server 205 may transmit a command signal to locate the MU 100 that is lost. The command signal may be tailored specifically for the MU 100. The server 205 may tailor the command signal by being aware that the MU 100 is lost within the operating area of the network 200. For example, if the network 200 is for a retail facility, at the end of each day, the MUs may be placed in cradles to recharge the battery. The cradles may be associated with the network 200 and may include a trigger that is depressed to transmit a signal to the server 205. Placement in the cradle may indicate to the server 205 that the MU is accounted for. If the MU 100 is not placed in a cradle, then the server 205 may determine that the MU 100 is missing. In another example, the server 205 may broadcast a query beacon. The MUs of the network 200 may reply to the query beacon. A first reply may be a status of the MU such as “in use,” “idle,” “suspended,” etc. Thus, the MU 100 may transmit a reply that the MU 100 is “idle.” When the status indicates that there is a possibility that the MU is lost, the server 205 may broadcast a further query beacon. The further query beacon may activate a prompt on the MU (e.g., “is this MU in use?”). If a response is entered to the prompt, the response may be transmitted to the server 205. Since the MU 100 is lost, no response may be transmitted from the MU 100 which indicates to the server 205 that the MU 100 is lost. In a further example, the last known user of the MU 100 that is lost may tell the network administrator. The network administrator may enter data indicating to the server 205 that the MU 100 is lost. In yet another example, the MU 100 may be associated with the network 200. As discussed above, the transceiver 120 of the MU 100 may remain activated. Thus, the transceiver 120 may be transmitting, for example, status signals to the server 205. The server 205 may receive the status signals and when a predetermined permutation of statuses is reached (e.g., “idle for 5 minutes-idle for 10 minutes-idle for 15 minutes-idle for 20 minutes”), the server 205 may determine that the MU 100 is lost.

According to a further exemplary embodiment of the present invention, the MU 100 may transmit a query to the server 205 asking if the MU 100 is to perform a task. The query transmission may be performed at a variety of times. In a first example, a periodic transmission may be sent every ten minutes, every fifteen minutes, every half hour, every hour, etc. In a second example, the MU 100 may determine a status thereof. If the status indicates that the MU 100 has been idle for a predetermined amount of time, the query may be transmitted from the MU 100. In a third example, a status of a component of the MU 100 may determine whether the query is to be transmitted. For example, if the battery 115 has discharged a predetermined amount of charge and/or at least a predetermined amount of charge remains, the MU 100 may transmit the query to the server 205.

Whether the server 205 is aware that the MU 100 is lost and/or receives the query from the MU 100, the server 205 may generate the command signal to be received by the MU 100. As illustrated in FIG. 2, the server 205 may generate the command signal, forward the command signal to the switch 215 that determines that the command signal is to be forwarded to the AP 220. The AP 220 may transmit the command signal to the MU 100 that is wirelessly associated therewith. The command signal may indicate that the speaker 125 is to be activated at a sufficient volume so that a user within a predetermined area may locate the MU 100 by following the source of the sound emitted from the speaker 125.

It should be noted that the server 205 performing the above described functionalities is only exemplary. Other network components may be configured to perform the above described functionalities. For example, a network switch, a network management arrangement (NMA), an access point, etc. may be configured to perform the functionalities of the server 205 such as transmitting the query signal, transmitting the command signal, etc.

It should be noted that the command signal indicating that the speaker 125 emit a sound is only exemplary. The command signal may further indicate to the MU 100 that other indicia may be activated. For example, if the MU 100 includes a display with a background illumination, the command signal may indicate that the background illumination is to be activated periodically (e.g., once per second) so that a user may listen for the sound from the speaker 125 and may also visually locate the MU 100. The command signal may also be used for additional purposes. For example, as discussed above, the MU 100 may transmit the query to the server 205 when the battery 115 has reached a predetermined capacity. The command signal may indicate to the MU 100 that a prompt is to be displayed. The prompt may alert the user that the battery 115 is almost completely discharged.

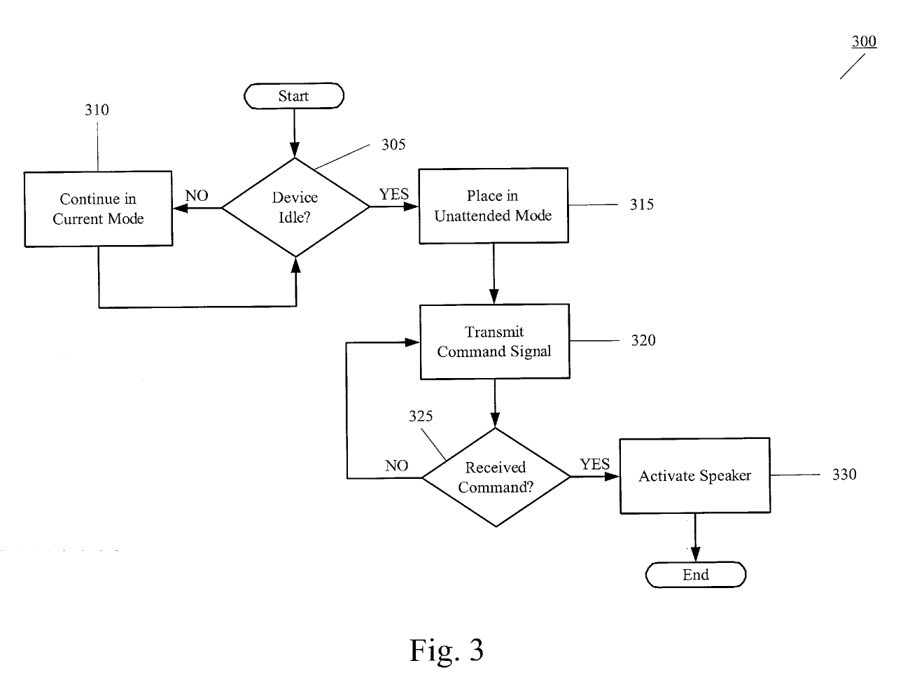

FIG. 3 shows a method 300 for locating a lost MU according to an exemplary embodiment of the present invention. The method 300 will be described in the standpoint of the lost MU. Specifically, the method 300 will be described according to the exemplary embodiment discussed above relating to when the MU 100 has become idle which indicates that the MU 100 is lost. The method 300 will be described with reference to the MU 100 of FIG. 1 and the network 200 of FIG. 2. It should be noted that the method 300 is for one exemplary embodiment of the present invention. When other criteria are used as discussed above, the method 300 may include additional steps and/or alternate steps. Some exemplary additional and/or alternate steps will be discussed below.

In step 305, a determination is made whether the MU 100 is idle. The processor 105 may include an internal clock that determines a length of time in which the MU 100 has not been used. A predetermined length of time may serve as a minimum time in which the MU 100 is idle to determine whether the MU 100 is lost. The predetermined length of time may be different for each environment in which the MU 100 is used. For example, in a warehouse environment, the MU 100 may be used frequently. Thus, the predetermined length of time may be short such as 15 minutes, 30 minutes, etc. In another example, in a retail environment, the MU 100 may not be used as frequently. Thus, the predetermined length of time may be longer such as 1 hour, 2 hours, etc.

If step 305 determines that the MU 100 is not idle (i.e., in use), the method continues to step 310 where a current mode in which the MU 100 is operating is maintained. For example, if the MU 100 is in an “active state,” the MU 100 maintains the “active state.” The MU 100 may have been idle for a length of time. However, the length of time may not have exceeded the predetermined length of time that would indicate the MU 100 being lost. Subsequently, the method 300 may return to step 305 to re-determine whether the MU 100 is idle. The return to step 305 may be performed on a variety of bases. For example, a periodic determination of whether the device is idle may be performed such as every 30 minutes, every hour, etc. The periodicity may also be a function of the predetermined length of time.

If step 305 determines that the MU 100 is idle, the method 300 continues to step 315 where the MU 100 is placed in an unattended mode. The unattended mode may function in a substantially similar manner as a “suspend mode.” For example, components of the MU 100 may be deactivated to preserve as much charge on the battery 115. However, as discussed above, the transceiver 120 and the processor 105 may still be activated. The unattended mode may trigger upon the predetermined length of time. In contrast to the “suspend mode,” the unattended mode may include a longer predetermined length of time. Thus, the MU 100 may already be in the “suspend mode” when the MU 100 is placed in the unattended mode. The unattended mode may indicate that the MU 100 is lost. Therefore, the predetermined length of time to place the MU 100 in the unattended mode may be longer.

In step 320, the server 205 transmits a command signal. As discussed above, the server 205 may be aware that the MU 100 is lost. Since the transceiver 120 and the processor 105 are still activated, the command signal may be received by the MU 100. It should be noted that another exemplary embodiment may include the MU 100 transmitting a query to the server 205 requesting if an action is to be taken by the MU 100. Consequently, the server 205 may transmit the command signal.

In step 325, a determination is made whether a command is received from the MU 100. The command may be a response of the query that was transmitted in step 320. In a first exemplary embodiment, the query transmitted in step 320 may include an indication that the MU 100 was placed in the unattended mode. In response to the query and the fact that the MU 100 is in this mode, the server 205 may generate the command signal. In a second exemplary embodiment, the determination of step 325 may be dependent upon whether the server 205 is aware that the MU 100 is lost. As discussed above, several methods may be used for the sever 205 to know whether the MU 100 is lost. Reception of the query from the MU 100 may further indicate to the server 205 that the MU 100 still includes a charge on the battery 115. If the server 205 is aware that the MU 100 is lost and receives the query, the server 205 may generate the command signal.

If no command is received in step 325, the method 300 returns to step 320 where the server 205 is contacted by the MU 100. The contacting with the sever 205 by the MU 100 may be performed at a variety of times. For example, a periodic contacting may be performed where the MU 100 transmits the query at predetermined times such as every 10 minutes, 20 minutes, etc.

If the command is received by the MU 100 in step 325, the method 300 continues to step 330. In step 330, the speaker 125 is activated. That is, the command signal from the server 205 may indicate to the processor 105 that the speaker 125 is to be activated. Once activated, a user may listen for a sound emitted from the speaker 125 to attempt to find the lost MU 100.

It should be noted that the method 300 may include additional steps. For example, after step 330, a determination may be made whether the command signal received in step 325 included additional commands for the MU 100 to execute. The command signal may have further included the display of the MU 100 that includes a backlight to flash periodically to further aid in locating the lost MU 100.

The method 300 may also include alternate embodiments where various steps are omitted or other steps are included. For example, step 315 may not be included. If the device is determined to be idle in step 305, the MU 100 may automatically assume that the MU 100 is lost and therefore, immediately contacts the server 205 (step 320). In another example, the server 205 may be aware that the MU 100 is lost. Thus, steps 305-320 may be replaced with steps to indicate to the server 205 that the MU 100 is lost. The server 205 may then generate the command signal and the method 300 may continue with step 325.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a mobile device associated with a network via a wireless transceiver, the mobile device including an audio output component; and
a network component receiving a query and generating a command signal to be transmitted to the mobile device in response to the query, the command signal indicating to the mobile device to activate the audio output component,
wherein a sound emitted from the audio output component is used to locate the mobile device when a location of the mobile device is unknown.

2. The system of claim 1, wherein the transceiver is activated independent of a mode in which the mobile device operates.

3. The system of claim 1, wherein the query is transmitted from the mobile device when the mobile device is placed in an unattended mode.

4. The system of claim 3, wherein the mobile device operates in the unattended mode after a predetermined time of being idle.

5. The system of claim 3, wherein the unattended mode deactivates other components of the mobile device.

6. The system of claim 1, wherein the query is received from one of the mobile device and a further device.

7. The system of claim 1, wherein the query indicates that the location of the mobile device is unknown.

8. The system of claim 7, wherein the network component further determines that the location of the mobile device is unknown by at least one of the network component not receiving a request from a beacon requesting a response, the network component receiving a status signal from the mobile device that is used to determine that the location of the mobile device is unknown, and an entering of an indication to the network component that the location of the mobile device is unknown.

9. The system of claim 1, wherein the mobile device further includes an illumination component, wherein the command signal further indicates activating the illumination component.

10. The system of claim 1, wherein the network component is one of a server, a switch, a network management arrangement, and an access point.

11. A mobile device, comprising:
a transceiver used to associate with a network; and
an audio output component emitting a sound when the mobile device receives a command signal from the network, the command signal being generated in response to a query, the command signal being generated when a location of the mobile device is unknown.

12. The mobile device of claim 11, wherein the transceiver is activated independent of a mode in which the mobile device operates.

13. The system of claim 11, wherein the query is transmitted from the mobile device when the mobile device is placed in an unattended mode.

14. The mobile device of claim 13, wherein the mobile device operates in the unattended mode after a predetermined time of being idle.

15. The mobile device of claim 13, wherein the unattended mode deactivates other components of the mobile device.

16. The mobile device of claim 11, wherein the query is transmitted from the mobile device periodically until the mobile device receives the command signal.

17. The mobile device of claim 11, wherein the command signal is received when the network is further aware that the location of the mobile device is unknown.

18. The mobile device of claim 11, further comprising:
an illumination component, wherein the command signal further indicates that the task includes activating the illumination component.

19. The mobile device of claim 11, wherein the mobile device receives the command signal from a network component of the network, the network component being one of a server, a switch, a network management arrangement, and an access point.

20. A mobile device, comprising:
a transceiver used to associate with a network; and
an audio outputting means for emitting a sound when the mobile device receives a command signal from the network, the command signal being generated in response to a query, the command signal being generated when a location of the mobile device is unknown.
